(19) United States
(12) Patent Application Publication
(10) Pub. No.: US 2014/0176458 A1
(43) Pub. Date: Jun. 26, 2014

(54) ELECTRONIC DEVICE, CONTROL METHOD AND STORAGE MEDIUM

(71) Applicant: Kabushiki Kaisha Toshiba, Tokyo (JP)

(72) Inventor: Kyohei Matsuda, Ome-shi (JP)

(73) Assignee: KABUSHIKI KAISHA TOSHIBA, Tokyo (JP)

(21) Appl. No.: 14/017,181

(22) Filed: Sep. 3, 2013

Related U.S. Application Data
(63) Continuation of application No. PCT/JP2013/058102, filed on Mar. 21, 2013.

(30) Foreign Application Priority Data
Dec. 21, 2012 (JP) 2012-279640

(51) Int. Cl. G06F 3/041

(52) U.S. Cl. CPC G06F 3/0416
USPC 345/173

(57) ABSTRACT

According to one embodiment, an electronic device includes a touch screen display, a sensor and an adjuster. The touch screen display includes a touch panel. The sensor is capable of detecting a direction of gravitational force. The adjuster is configured to adjust the sensitivity of the touch panel by determining which of a first direction close to an upwardly vertical direction and a second direction close to a downwardly vertical direction a screen of the touch screen display is made to face based on a detection signal from the sensor.

### CROSS-REFERENCE TO RELATED APPLICATIONS

This application is a Continuation Application of PCT Application No. PCT/JP2013/058102, filed Mar. 21, 2013 and based upon and claiming the benefit of priority from Japanese Patent Application No. 2012-279640, filed Dec. 21, 2012, the entire contents of all of which are incorporated herein by reference.

### FIELD

Embodiments described herein relate generally to a control technique suitable for an electronic device including a touch-screen display.

### BACKGROUND

In recent years, electronic devices such as tablet terminals, smartphones which can be operated by a battery, and are easily portable are widespread. Most of the electronic devices of this kind are each provided with a touch-screen display in addition to (mechanical) buttons in order to facilitate an input operation to be carried out by the user.

By touching an object such as an icon, menu, and the like displayed on the touch screen display with a finger, the user can instruct the electronic device to execute a function associated with the icon or the menu.

Regarding the input operation (touch input) using the touch screen display, various proposals have been made until now.

Incidentally, for example, when a tablet terminal is to be operated, it is conceivable that there is, depending on the user, a case where the tablet is held by a single hand of the user, and is operated by the user lying on his or her back. In such a case, the screen of the tablet terminal faces the ground direction. In this state, when the user tries to carry out an operation of the touch panel or buttons, the tablet terminal becomes unstable, and a touch operation or the like not intended by the user is liable to occur.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing an external appearance of an electronic device of a first embodiment.

FIG. 2 is an exemplary view showing the system configuration of the electronic device of the first embodiment.

FIG. 3 is an exemplary view showing functional blocks associated with sensitivity adjustment of an input device in the electronic device of the first embodiment.

FIG. 4 is an exemplary view showing an example of the utilization form of the electronic device of the first embodiment.

FIG. 5 is an exemplary flowchart showing an operation procedure of a touch panel driver operating on the electronic device of the first embodiment.

FIG. 6 is an exemplary flowchart showing an operation procedure of a button driver operating on the electronic device of the first embodiment.

FIG. 7 is an exemplary view showing functional blocks associated with sensitivity adjustment of an input device in an electronic device of a second embodiment.

FIG. 8 is an exemplary view showing a relationship between an orientation of a screen and an orientation of an image on the screen in the electronic device of the second embodiment.

FIG. 9 is an exemplary flowchart showing an operation procedure of a touch panel driver operating on the electronic device of the second embodiment.

FIG. 10 is an exemplary flowchart showing an operation procedure of a button driver operating on the electronic device of the second embodiment.

### DETAILED DESCRIPTION

Various embodiments will be described hereinafter with reference to the accompanying drawings.

In general, according to one embodiment, an electronic device includes a touch screen display, a sensor and an adjuster. The touch screen display includes a touch panel. The sensor is capable of detecting a direction of gravitational force. The adjuster is configured to adjust the sensitivity of the touch panel by determining which of a first direction close to an upwardly vertical direction and a second direction close to a downwardly vertical direction a screen of the touch screen display is made to face based on a detection signal from the sensor.

### First Embodiment

First, a first embodiment will be described below.

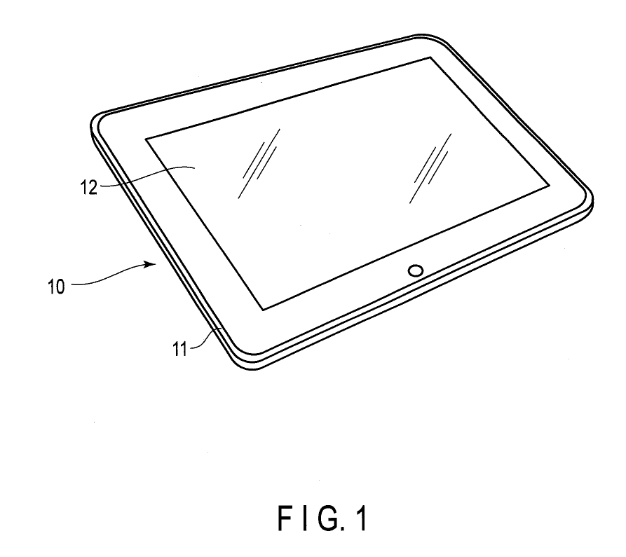

An electronic device of this embodiment may be realized as a portable electronic device such as a tablet terminal, smartphone or the like which enables touch input by a finger. FIG. 1 is an exemplary perspective view showing an external appearance of the electronic device according to this embodiment. As shown in FIG. 1, here, a case where the electronic device is realized as a tablet terminal 10 is assumed. The tablet terminal 10 includes a main body 11 and a touch screen display 12. The touch screen display 12 is attached to the main body 11 in such a manner that the display 12 is laid on a top surface of the main body 11.

The main body 11 has a thin box-like housing. A flat panel display and a sensor configured to detect a contact position of a finger on the screen of the flat panel display are incorporated in the touch screen display 12. The flat panel display is, for example, a liquid crystal display (LCD). The sensor is, for example, a capacitive touch panel. The touch panel is provided to cover the screen of the flat panel display. Further, various types of buttons 13 (not shown) are provided on a side surface of the main body 11.

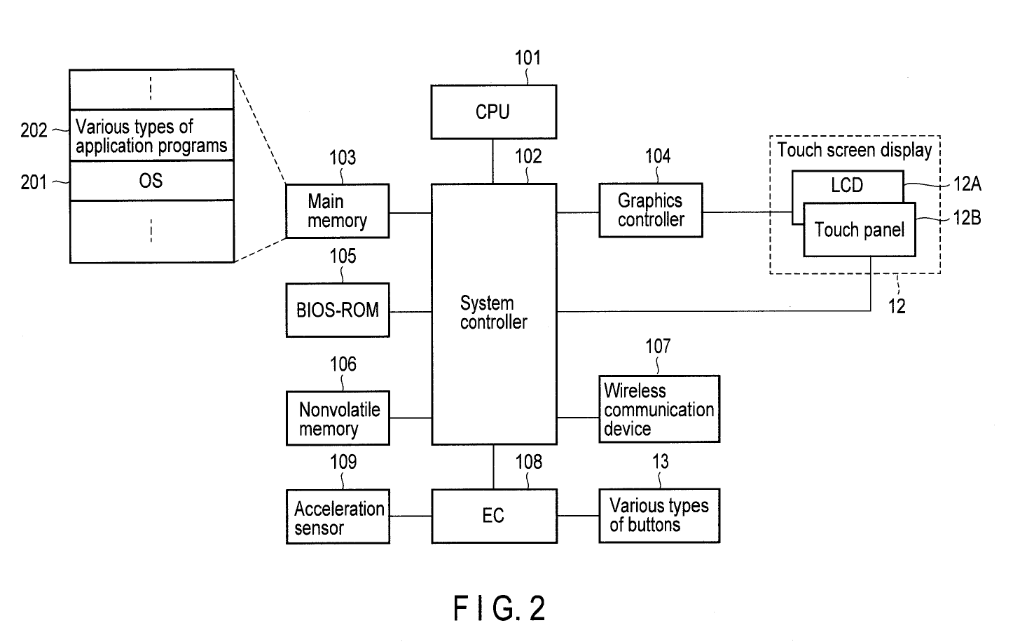

FIG. 2 is an exemplary view showing the system configuration of the tablet terminal 10.

As shown in FIG. 2, the tablet terminal 10 includes a CPU 101, a system controller 102, a main memory 103, a graphics controller 104, a BIOS-ROM 105, a nonvolatile memory 106, a wireless communication device 107, an embedded controller (EC) 108, an acceleration sensor 109, and the like.

The CPU 101 is a processor configured to control an operation of each of various types of modules in the tablet terminal 10. The CPU 101 executes various types of software to be loaded from the nonvolatile memory 106 into the main memory 103. These types of software include, an operating system (OS) 201, and various types of application programs 202.

Further, the CPU 101 also executes a basic input/output system (BIOS) stored in the BIOS-ROM 105. The BIOS is a program used for hardware control.

The system controller 102 is a device configured to connect a local bus of the CPU 101 and each of various types of components to each other. The system controller 102 also incorporates therein a memory controller configured to access-control the main memory 103. Further, the system controller 102 includes a function of executing communication with the graphics controller 104 through a serial bus or the like of the PCI EXPRESS standard.

The graphics controller 104 is a display controller configured to control an LCD 12A to be used as a display monitor of the tablet terminal 10. A display signal generated by the graphics controller 104 is sent to the LCD 12A. The LCD 12A displays a screen image on the basis of the display signal. On the LCD 12A, a touch panel 12B is arranged. The touch panel 12B is, for example, a capacitive pointing device configured to carry out input on the screen of the LCD 12A. A position on the screen at which a finger has come into contact with the screen is detected by the touch panel 12B.

The wireless communication device 107 is a device configured to execute wireless communication such as wireless communication of a wireless LAN, 3G mobile communication or the like. The EC 108 is a one-chip microcomputer including an embedded controller used for power management. Various types of buttons 13 and an acceleration sensor 109 are connected to the EC 108. The EC 108 includes a function of turning on/off the power to the tablet terminal 10 according to an operation of the power button to be carried out by the user. The acceleration sensor 109 is a sensor capable of detecting a direction of gravitational force, and the tablet terminal 10 can determine, for example, in which orientation the main body 11 is held by the user, and so on by uses of a detection signal of the acceleration sensor 109.

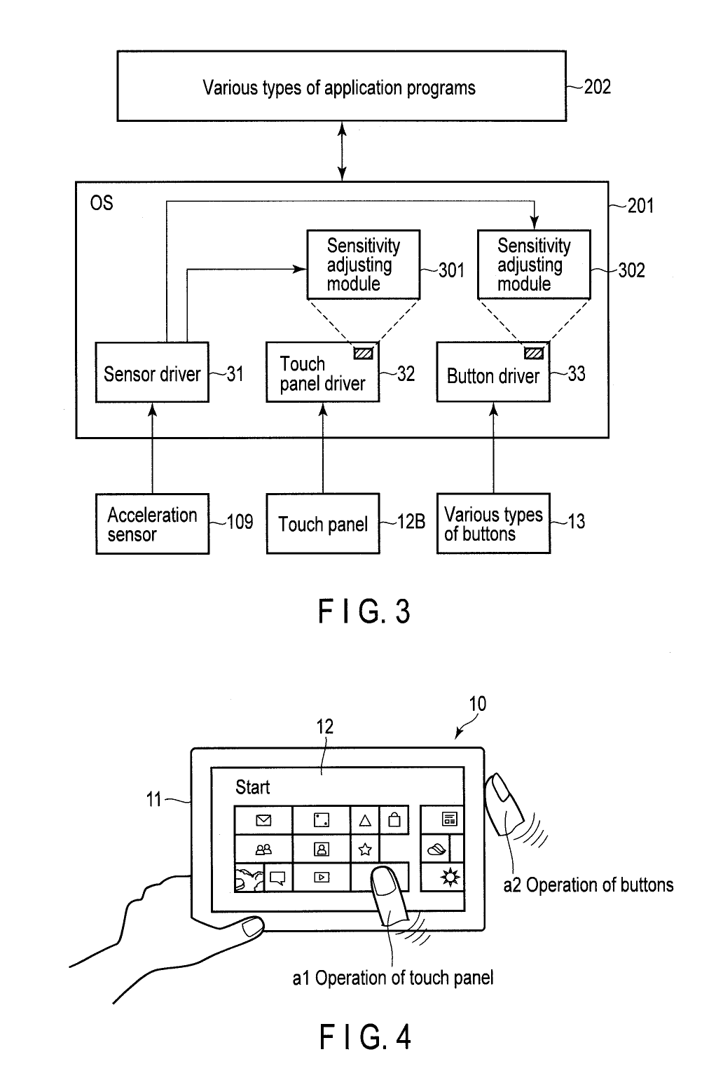

FIG. 3 is an exemplary view showing functional blocks associated with sensitivity adjustment of an input device in the tablet terminal 10 having the system configuration described above.

As shown in FIG. 3, the OS 201 includes a sensor driver 31, a touch panel driver 32 and a button driver 33. It should be noted that here, although an example in which each of the sensor driver 31, the touch panel driver 32 and the button driver 33 exists as one module in the OS 201 is shown, part or all (operating under the control of the OS 201) of these modules may exist as software separate from the OS 201.

The sensor driver 31 is a module configured to input a detection signal output from the acceleration sensor 109. The touch panel driver 32 is a module configured to input a detection signal output from the touch panel 12B. Coordinate information (X, Y) is included in the detection signal output from the touch panel 12B. The button driver 33 is a module configured to detect depression of various types of buttons 13.

Further, the touch panel driver 32 and the button driver 33 each include sensitivity adjusting modules 301 and 302, respectively. In the tablet terminal 10, the sensitivity adjusting modules 301 and 302 appropriately adjust the sensitivity of the touch panel 12B and various types of buttons 13, respectively on the basis of the detection signal from the acceleration sensor 109 input to the modules 301 and 302 by the sensor driver 31, and this point will be described below in detail.

FIG. 4 is an exemplary view showing one example of the utilization form of the tablet terminal 10.

As shown in FIG. 4, regarding the tablet terminal 10, a utilization form in which the main body 11 is held by one hand, and an operation (a1) of the touch panel 12B, and operation (a2) of various types of buttons 13 are carried out by other hand is often adopted.

Now, it is assumed that the user operates the tablet terminal 10 while lying on his or her back. In this case, the user's line of sight is directed to the ceiling side. In other words, the screen of the touch screen display 12 faces the ground direction. Accordingly, when the screen of the touch screen display 12 faces the ground direction, the user operates the tablet terminal 10 while lying on his or her back, and hence it can be presumed that the tablet terminal 10 is in an unstable state. In an unstable state, an operation (a1) of the touch panel 12B, and operation (a2) of various types of buttons which are not intended by the user are liable to occur.

Thus, the sensitivity adjusting module 301 of the touch panel driver 32 determines the direction faced by the screen of the touch screen display 12 on the basis of a detection signal from the acceleration sensor 109 input by the sensor driver 31 and, when the screen of the touch screen display 12 faces the ground direction, lowers the sensitivity of the touch panel 12B. As a result, the user is made to carry out the operation in a steady manner, whereby an operation of the touch panel 12B not intended by the user is prevented from occurring.

Further, the sensitivity adjusting module 302 of the button driver 33 also determines the direction faced by the screen of the touch screen display 12 on the basis of the detection signal from the acceleration sensor 109 input by the sensor driver 31 and, when the screen of the touch screen display faces the ground direction, lowers the sensitivity of the various types of buttons 13. As a result, the user is made to carry out the operation in a steady manner, whereby an operation of the various types of buttons 13 not intended by the user is prevented from occurring.

As a method of lowering the sensitivity of the touch panel 12B and various types of buttons 13, a method in which, for example, a manner of normally determining, when an operating state is maintained for a first period, that the operation has been carried out is changed to a manner of determining, when an operating state is maintained for a second period longer than the first period, that the operation has been carried out can be employed. The method is not limited to the above and, various methods such as a method of making a pressure value used as a threshold for determining that the operation has been carried out greater, method of making a contact area value greater (in the case of the touch panel 12B), and the like can be adopted.

It should be noted that although, for example, a utilization form in which the tablet terminal 10 is operated in a state where the terminal 10 is not held by a hand, but is placed on, for example, a desk is also adopted, in this case, the screen of the touch screen display 12 always faces the ceiling direction, and hence the sensitivity of the touch panel 12B, and various types of buttons 13 is not lowered.

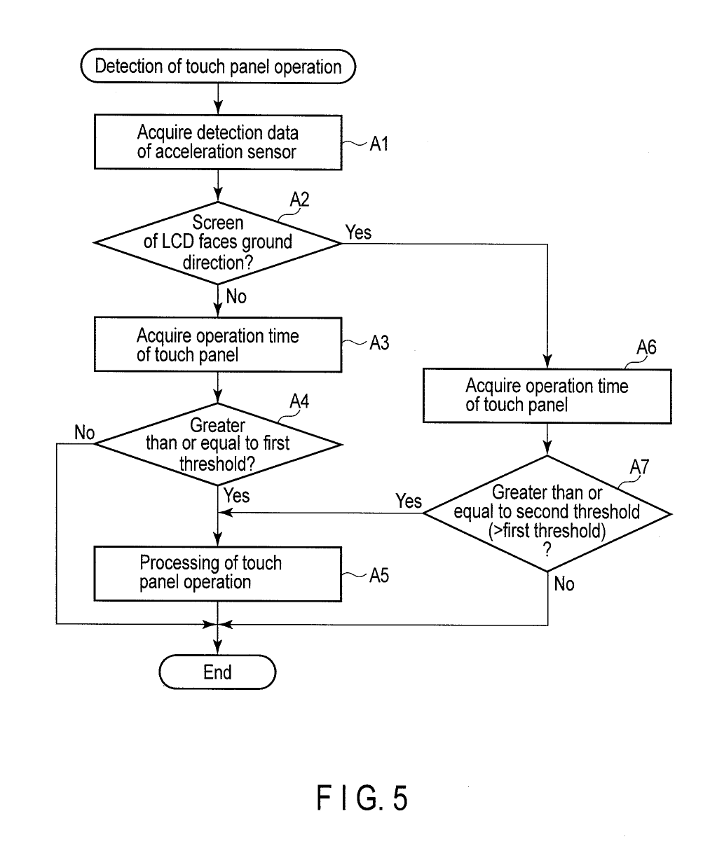

FIG. 5 is an exemplary flowchart showing an operation procedure of the touch panel driver 32.

Upon detection of an operation of the touch panel 12B, the touch panel driver 32 acquires detection data of the acceleration sensor 109 from the sensor driver 31 (block A1). The touch panel driver 32 determines the direction faced by the screen of the LCD 12A on the basis of the acquired detection data of the acceleration sensor 109 (block A2).

When the screen of the LCD 12A is not made to face the ground direction (NO in block A2), the touch panel driver 32 acquires the operation time of the touch panel 12B (block A3), and compares the acquired operation time with a first threshold (block A4). When the operation time is greater than or equal to the first threshold (YES in block A4), the touch panel driver 32 determines that the touch panel 12B has been operated, and executes processing to be carried out when the touch panel 12B is operated (block A5).

On the other hand, when the screen of the LCD 12A is made to face the ground direction (YES in block A2), the touch panel driver 32 acquires the operation time of the touch panel 12B (block A6), and compares the operation time with a second threshold greater than the first threshold (block A7). When the operation time is greater than or equal to the second threshold (YES in block A7), the touch panel driver 32 determines that the touch panel 12B has been operated, and executes the processing to be carried out when the touch panel 12B is operated (block A5).

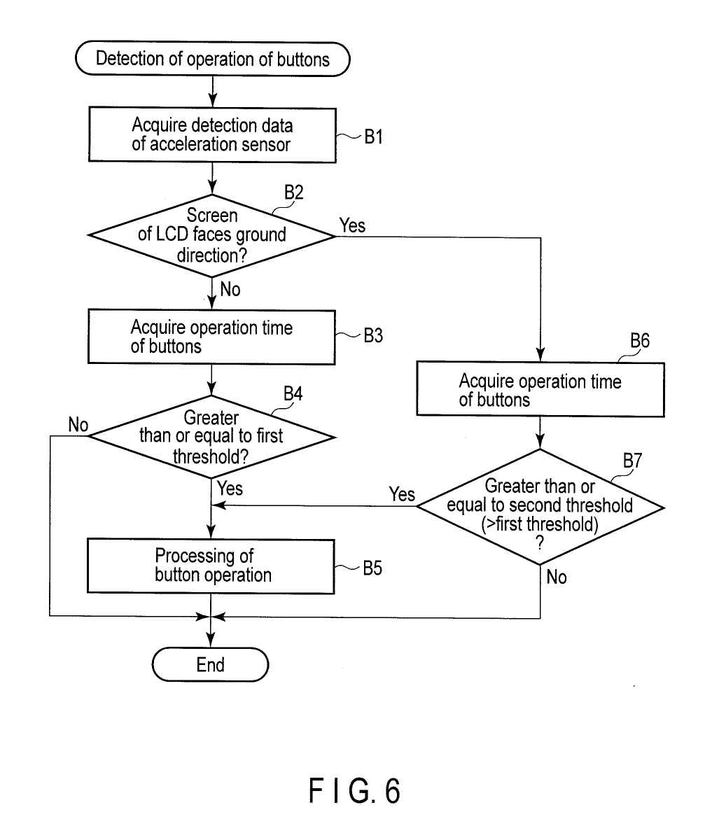

FIG. 6 is an exemplary flowchart showing an operation procedure of the button driver 33.

Upon detection of an operation of the various types of buttons 13, the button driver 33 acquires detection data of the acceleration sensor 109 from the sensor driver 31 (block B1). The button driver 33 determines the direction faced by the screen of the LCD 12A on the basis of the acquired detection data of the acceleration sensor 109 (block B2).

When the screen of the LCD 12A is not made to face the ground direction (NO in block B2), the button driver 33 acquires the operation time of the various types of buttons 13 (block B3), and compares the acquired operation time with the first threshold (block B4). When the operation time is greater than or equal to the first threshold (YES in block B4), the button driver 33 determines that the various types of buttons 13 have been operated, and executes processing to be carried out when the various types of buttons are operated (block B5).

On the other hand, when the screen of the LCD 12A is made to face the ground direction (YES in block B2), the button driver 33 acquires the operation time of the various types of buttons 13 (block B6), and compares the operation time with the second threshold greater than the first threshold (block B7). When the operation time is greater than or equal to the second threshold (YES in block B7), the button driver 33 determines that the various types of buttons 13 have been operated, and executes the processing to be carried out when the various types of buttons are operated (block B5).

As described above, the tablet terminal 10 of this embodiment makes it possible to appropriately adjust the sensitivity of the touch panel 12B and various types of buttons 13 according to the situation of each moment.

### Second Embodiment

Next, a second embodiment will be described below.

In the first embodiment, the mechanism in which when the screen of the touch screen display 12 faces the ground direction, and the user operates the tablet terminal 10 while lying on his or her back, the tablet terminal 10 presumes that the terminal 10 is in an unstable state, and lowers the sensitivity of the touch panel 12B and various types of buttons 13 has been described.

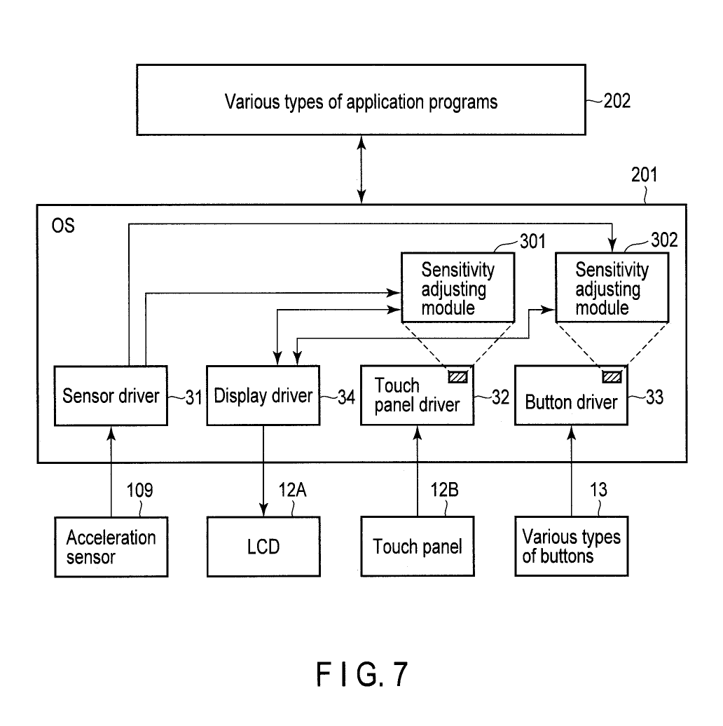

Conversely, in the second embodiment, when the user operates the tablet terminal 10 while lying on his or her side, the tablet terminal 10 presumes that the terminal 10 is in an unstable state, and lowers the sensitivity of the touch panel 12B and various types of buttons. FIG. 7 is an exemplary view showing functional blocks associated with sensitivity adjustment of an input device in a tablet terminal 10. It should be noted that constituent elements identical to the first embodiment are denoted by identical reference symbols.

As shown in FIG. 7, in the second embodiment, each of a sensitivity adjusting module 301 of a touch panel driver 32 and a sensitivity adjusting module 302 of a button driver 33 further acquires information from a display driver 34 in addition to information from a sensor driver 31. The display driver 34 is a module configured to control image display on an LCD 12A. More specifically, each of the sensitivity adjusting modules 301 and 302 acquires an orientation of an image on the LCD 12A from the display driver 34. It should be noted that the display driver 34 also may exist not as one module in the OS 201, but as software (operating under the control of the OS 201) separate from the OS 201.

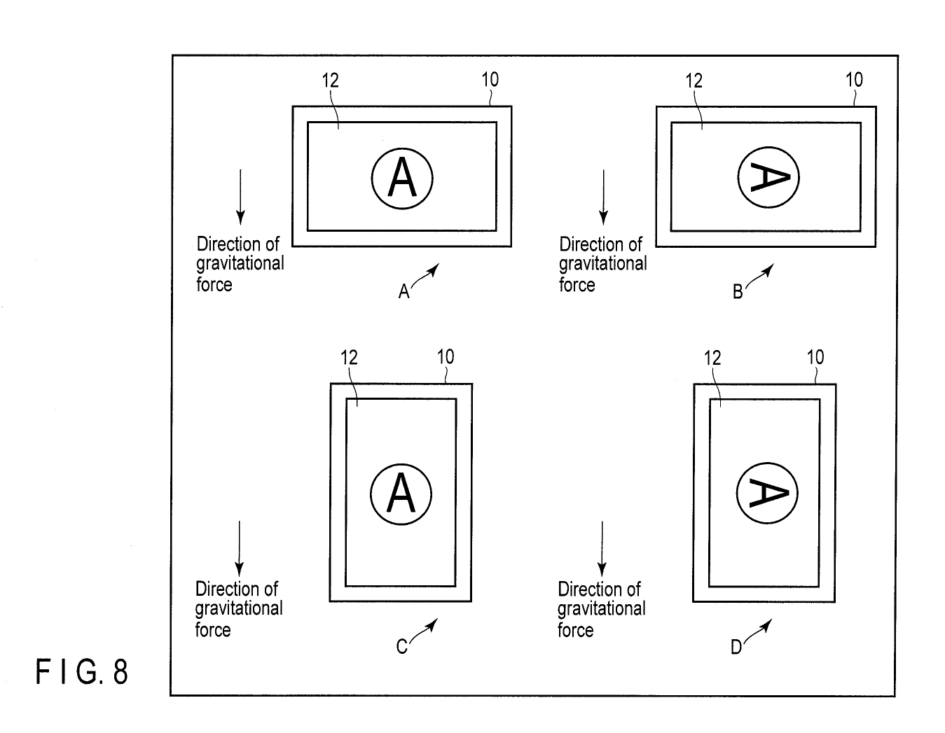

FIG. 8 is an exemplary view showing a relationship between an orientation of a screen of a touch screen display 12 of the tablet terminal 10 and an orientation of an image on the touch screen display 12. In FIG. 8, each of “A”, “B”, “C” and “D” shows a situation in which the tablet terminal 10 is used in a state where the main body 11 is set upright (the screen of the touch screen display 12 is arranged in the horizontal direction). It should be noted that in this embodiment, when the tablet terminal 10 is used in a state where the main body 11 is laid on its side (the screen of the touch screen display 12 is arranged in the vertical direction), the control for sensitivity adjustment of the touch panel 12B and various types of buttons 13 does not work. It can be determined whether the tablet terminal 10 is used in the state where the main body 11 is set upright or the tablet terminal 10 is used in the state where the main body 11 is laid on its side on the basis of a detection signal from an acceleration sensor 109. Further, when the tablet terminal 10 is used in the state where the main body 11 is laid on its side, the sensitivity of the touch panel 12 and various types of buttons 13 may be adjusted according to the principle described in the first embodiment.

As shown in FIG. 8, it is assumed that in the tablet terminal 10, the screen of the touch screen display 12 is rectangular. Further, it is also assumed that the tablet terminal 10 can display an image in both the state where the longitudinal direction of the screen of the touch screen display 12 is arranged in the horizontal direction (so-called landscape orientation), and state where the longitudinal direction of the screen of the touch screen display 12 is arranged in the vertical direction (so-called portrait orientation). In FIG. 8, “A” and “D” are image-displayed in the landscape orientation, and “B” and “C” are image-displayed in the portrait orientation. Each of the sensitivity adjusting modules 301 and 302 acquires information concerning the orientation (i.e., the landscape orientation or the portrait orientation) in which the image is displayed from the display driver 34.

Further, in FIG. 8, “B” and “D” in each of which the orientation of the image is in the horizontal direction are in the state where it can be presumed, for example, that the user operates the tablet terminal 10 while lying on his or her side. Although it is possible, by using only the detection signal from the acceleration sensor 109 input by the sensor driver 31, to determine that the actual state is in one of “A” and

“B” or in one of “C” and “D”, it is not possible to determine in which one of “A” and “B” or in which one of “C” and “D” the actual state is.

Further, although it is possible, by using only the information (landscape or portrait) acquired from the display driver 34, to determine that the actual state is in one of “A” and “D” or in one of “B” and “C”, it is not possible to determine in which one of “A” and “D” or in which one of “B” and “C” the actual state is. Thus, on the basis of both the detection signal from the acceleration sensor 109 input by the sensor driver 31, and information (landscape or portrait) acquired from the display driver 34, the sensitivity adjusting modules 301 and 302 determine the four states “A”, “B”, “C” and “D” shown in FIG. 8, more specifically the modules 301 and 302 determine the states “B” and “D”. In the case of the states “B” and “D”, the tablet terminal 10 is regarded as being in an unstable state, and the sensitivity of the touch panel 12B and various types of buttons 13 is lowered by the sensitivity adjusting modules 301 and 302.

As a result, as in the case of the first embodiment, the user is made to carry out the operation in a steady manner, whereby an operation of the touch panel 12B, and operation of the various types of buttons 13 not intended by the user can be prevented from occurring.

It should be noted that here, although an example in which the screen of the touch screen display 12 is rectangular has been shown in order to make the description easy to understand, the screen of the touch screen display 12 may be, for example, square.

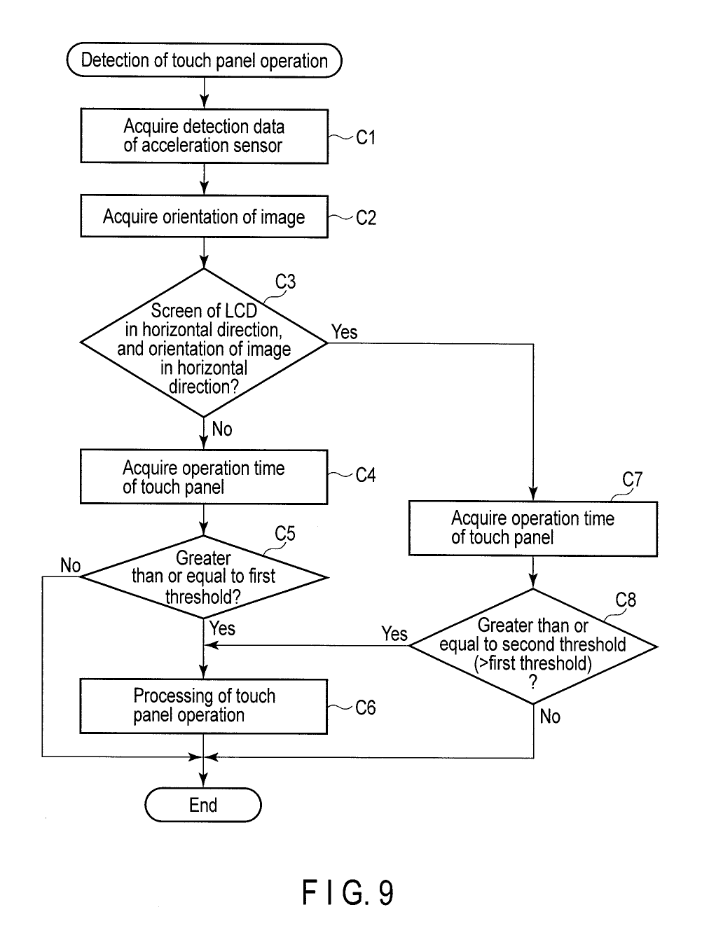

FIG. 9 is an exemplary flowchart showing an operation procedure of the touch panel driver 32.

Upon detection of an operation of the touch panel 12B, the touch panel driver 32 acquires detection data of the acceleration sensor 109 from the sensor driver 31 (block C1), and further acquires the orientation of an image on the LCD 12A from the display driver 34 (block C2). The touch panel driver 32 determines whether or not the screen of the LCD 12A is arranged in the horizontal direction, and whether or not the orientation of the image is in the horizontal direction on the basis of the acquired detection data of the acceleration sensor 109 and orientation of the image on the LCD 12A (block C3).

When the determination conditions of block C3 are not satisfied (NO in block C3), the touch panel driver 32 acquires the operation time of the touch panel 12B (block C4), and compares the acquired operation time with a first threshold (block C5). When the operation time is greater than or equal to the first threshold (YES in block C5), the touch panel driver 32 determines that the touch panel 12B has been operated, and executes processing to be carried out when the touch panel is operated (block C6).

On the other hand, when the determination conditions of block C3 are satisfied (YES in block C3), the touch panel driver 32 acquires the operation time of the touch panel 12B (block C7), and compares the operation time with a second threshold greater than the first threshold (block C8). When the operation time is greater than or equal to the second threshold (YES in block C8), the touch panel driver 32 determines that the touch panel 12B has been operated, and executes processing to be carried out when the touch panel is operated (block C6).

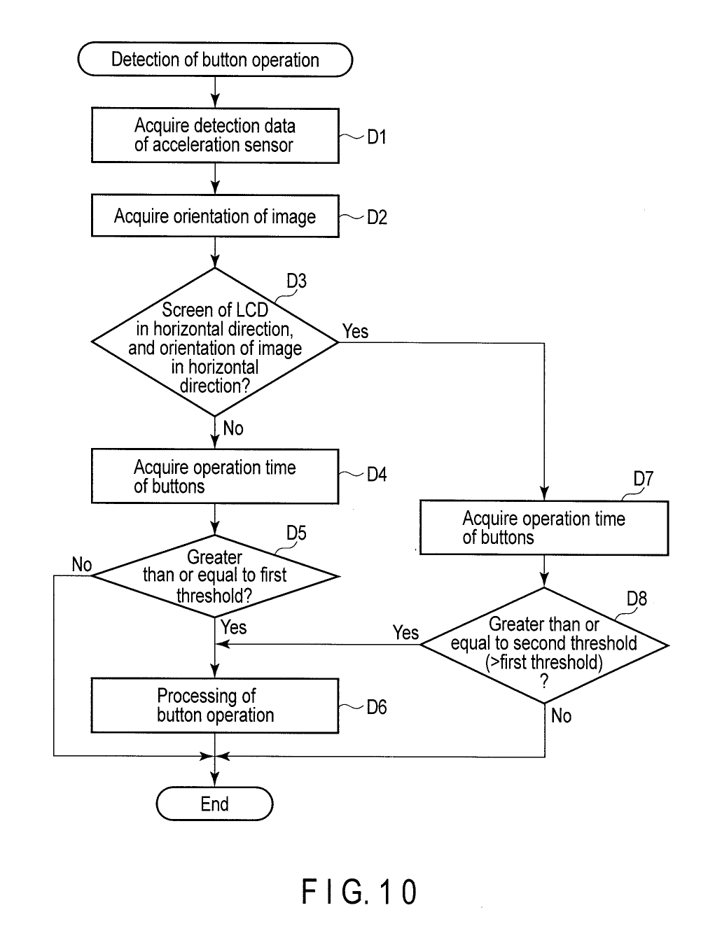

FIG. 10 is an exemplary flowchart showing an operation procedure of the button driver 33.

Upon detection of an operation of the various types of buttons 13, the button driver 33 acquires detection data of the acceleration sensor 109 from the sensor driver 31 (block D1), and further acquires the orientation of an image on the LCD 12A from the display driver 34 (block D2). The button driver 33 determines whether or not the screen of the LCD 12A is arranged in the horizontal direction, and whether or not the orientation of the image is in the horizontal direction on the basis of the acquired detection data of the acceleration sensor 109 and orientation of the image on the LCD 12A (block D3).

When the determination conditions of block D3 are not satisfied (NO in block D3), the button driver 33 acquires the operation time of the various types of buttons 13 (block D4), and compares the acquired operation time with the first threshold (block D5). When the operation time is greater than or equal to the first threshold (YES in block D5), the button driver 33 determines that the various types of buttons 13 have been operated, and executes processing to be carried out when the various types of buttons are operated (block D6).

On the other hand, when the determination conditions of block D3 are satisfied (YES in block D3), the button driver 33 acquires the operation time of the various types of buttons (block D7), and compares the operation time with the second threshold greater than the first threshold (block D8). When the operation time is greater than or equal to the second threshold (YES in block D8), the button driver 33 determines that the various types of buttons 13 have been operated, and executes processing to be carried out when the various types of buttons are operated (block D6).

As described above, the tablet terminal 10 of this embodiment also makes it possible to appropriately adjust the sensitivity of the touch panel 12B and various types of buttons 13 according to the situation of each moment.

It should be noted that all the operation procedures of this embodiment can be realized by software, and hence by introducing the software into a normal computer through a computer-readable storage medium, an advantage identical to this embodiment can easily be realized.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a touch screen display comprising a touch panel;
a sensor capable of detecting a direction of gravitational force; and
an adjuster configured to adjust the sensitivity of the touch panel by determining which of a first direction close to an upwardly vertical direction and a second direction close to a downwardly vertical direction a screen of the touch screen display is made to face based on a detection signal from the sensor.

2. The device of claim 1, wherein the adjuster is configured to lower the sensitivity of the touch panel, when the screen is made to face the second direction.

3. The device of claim 2, wherein the adjuster is configured to lower the sensitivity of the touch panel by making a threshold indicating a duration time of contact with the touch screen display greater, the duration time being used to determine that the contact with the touch screen display is a touch operation on the touch screen display.

4. The device of claim 1, further comprising:
a hardware button; and
a second adjuster configured to adjust the sensitivity of the hardware button by determining which of the first direction and the second direction the screen is made to face based on a detection signal from the sensor.

5. The device of claim 4, wherein the second adjuster is configured to lower the sensitivity of the hardware button, when the screen is made to face the second direction.

6. The device of claim 5, wherein the second adjuster is configured to lower the sensitivity of the hardware button by making a threshold indicating a duration time of depression of the hardware button greater, the duration time being used to determine that the depression of the hardware button is a button operation.

7. A control method of an electronic device comprising a touch screen display comprising a touch panel, the method comprising:
detecting a direction which a screen of the touch screen display is made to face; and
adjusting the sensitivity of the touch panel in response to which of an upwardly vertical first direction and a downwardly vertical second direction the screen is made to face.

8. A computer-readable, non-transitory storage medium having stored thereon a computer program executable by a computer, the computer program controlling the computer to execute function of:
detecting a direction which a screen of a touch screen display is made to face; and
adjusting the sensitivity of a touch panel in the touch screen display in response to which of an upwardly vertical first direction and a downwardly vertical second direction the screen is made to face.

9. An electronic device comprising:
a touch screen display comprising a touch panel;
a sensor capable of detecting a direction of gravitational force;
an acquirer configured to acquire an orientation of an image on a screen of the touch screen display; and
an adjuster configured to adjust the sensitivity of the touch panel by determining which of a first direction close to a vertical direction and a second direction close to a horizontal direction the screen is made to face, and determining which of the first direction and the second direction the orientation of the image is, based on a detection signal from the sensor and the orientation of the image on the screen acquired by the acquirer.

10. The device of claim 9, wherein the adjuster is configured to lower the sensitivity of the touch panel, when the screen is made to face the second direction, and when the orientation of the image is the second direction.

11. The device of claim 10, wherein the adjuster is configured to lower the sensitivity of the touch panel by making a threshold indicating a duration time of contact with the touch screen display greater, the duration time being used to determine that the contact with the touch screen display is a touch operation on the touch screen display.

12. The device of claim 9, further comprising:
a hardware button; and
a second adjuster configured to adjust the sensitivity of the hardware button by determining which of a first direction close to a vertical direction and a second direction close to a horizontal direction the screen is made to face, and determining which of the first direction and the second direction the orientation of the image is, based on a detection signal from the sensor and the orientation of the image on the screen acquired by the acquirer.

13. The device of claim 12, wherein the second adjuster is configured to lower the sensitivity of the hardware button, when the screen is made to face the second direction and when the orientation of the image is the second direction.

14. The device of claim 13, wherein the second adjuster is configured to lower the sensitivity of the hardware button by making a threshold indicating a duration time of depression of the hardware button greater, the duration time being used to determine that the depression of the hardware button is a button operation.

15. A control method of an electronic device comprising a touch screen display comprising a touch panel, the method comprising:
detecting a direction of gravitational force;
acquiring an orientation of an image on a screen of the touch screen display;
determining which of a first direction close to a vertical direction and a second direction close to a horizontal direction the screen is made to face, and determining which of the first direction and the second direction the orientation of the image is, based on the direction of gravitational force and the orientation of the image on the screen; and
adjusting the sensitivity of the touch panel in response to which of the first direction and the second direction the screen is made to face, and which of the first direction and the second direction the orientation of the image is.

16. A computer-readable, non-transitory storage medium having stored thereon a computer program executable by a computer, the computer program controlling the computer to execute function of:
detecting a direction of gravitational force;
acquiring an orientation of an image on a screen of a touch screen display;
determining which of a first direction close to a vertical direction and a second direction close to a horizontal direction the screen is made to face, and determining which of the first direction and the second direction the orientation of the image is, based on the direction of gravitational force and the orientation of the image on the screen; and
adjusting the sensitivity of a touch panel in the touch screen display in response to which of the first direction and the second direction the screen is made to face, and which of the first direction and the second direction the orientation of the image is.
